(19) United States
(12) Patent Application Publication
(10) Pub. No.: US 2007/0101380 A1
(43) Pub. Date: May 3, 2007

(54) Consolidated content apparatus

(76) Inventor: Thomas H. Szolyga, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,204

(22) Filed: Oct. 28, 2005

(51) Int. Cl. H04N 7/173; H04N 7/16

(52) U.S. Cl. 725/100; 725/131; 725/139; 725/151

(57) ABSTRACT

A consolidated content apparatus comprises a local area network including a plurality of communication ports adapted to connect to a plurality of communication mediums, wherein at least one of the ports is a television tuner port. A television receiver is coupled to the television port and configured to receive a television signal and to convert the television signal into television program packets. A multiport switch having a number of local ports is coupled to the communication ports and the television tuner. A plurality of client devices are coupled to the local area network and configured to communicate with the television receiver to tune at least one television channel and deliver the television program over the network to the client devices. Advantages of the invention include consolidation of content communications for customers, resulting in more robust and less expensive access to content delivery and communication.

### BACKGROUND

Communication of content over mediums like the internet, satellite, cable and telephone lines is improving rapidly. Consumers are finding that they often subscribe to a number of different services yet would like to find a way to consolidate services and functions where possible. Some of these services, for example television are not conveniently accessible throughout a home in the sense that to watch programs on multiple televisions, a customer must purchase or lease a set top tuner for each television. As the services converge, customers would like to have the ability to consolidate content delivery and take advantage of local area network technology to provide content deliver in a convenient manner throughout a home or business. Subscribers desire to have full functionality to communicate easily and conveniently over a plurality of mediums to which they may subscribe.

Thus, what it needed is a consolidated content apparatus that permits carriers to supply communication services to customers while also providing customers with the ability to communication over mediums to which they subscribe.

### SUMMARY

The invention provides a consolidated content apparatus that can be deployed by a customer and communicate with a wide range of mediums to enable the customer to obtain services to which they subscribe. The invention also works in conjunction with a wide range of client devices to provide the customer with a convenient interface in which to operate the system and view content throughout the deployed location.

A consolidated content apparatus comprises a local area network including a plurality of communication ports adapted to connect to a plurality of communication mediums, wherein at least one of the ports is a television tuner port. A television receiver is coupled to the television port and configured to receive a television signal and to convert the television signal into television program packets. A multiport switch having a number of local ports is coupled to the communication ports and the television tuner. A plurality of client devices are coupled to the local area network and configured to communicate with the television receiver to tune at least one television channel and deliver the television program over the network to the client devices.

In one aspect of the invention, the client devices are configured to send commands to the television receiver for tuning and communicating particular television programs to each client. In this aspect, the television receiver comprises a plurality of tuners each configured to tune a television signal and to convert the television signal into television program packets to be sent to the client devices responsive to commands from the respective client devices.

### DRAWINGS

The present invention is illustrated by way of example, and not by way of limitation, in the figures of the accompanying drawings and in which like reference numerals refer to similar elements and in which:

FIG. 1 depicts a consolidated content apparatus and local area network according to an embodiment of the invention;

FIG. 2 depicts a consolidated content apparatus and local area network according to another embodiment of the invention;

FIG. 3 depicts a television tuner according to an embodiment of the invention;

FIG. 4 depicts a client according to an embodiment of the invention; and

FIG. 5 depicts a storage structure according to an embodiment of the invention.

### DETAILED DESCRIPTION

The present invention is described in detail with reference to exemplary embodiments thereof as illustrated in the accompanying drawings. In the following description, numerous specific details are set forth in order to provide a description of the best mode of the invention. It will be apparent, however, to one skilled in the art, that the present invention may be practiced without some or all of these specific details. For example, while the invention describes internet protocol and Ethernet protocol, other communication protocols are anticipated to work well with the invention.

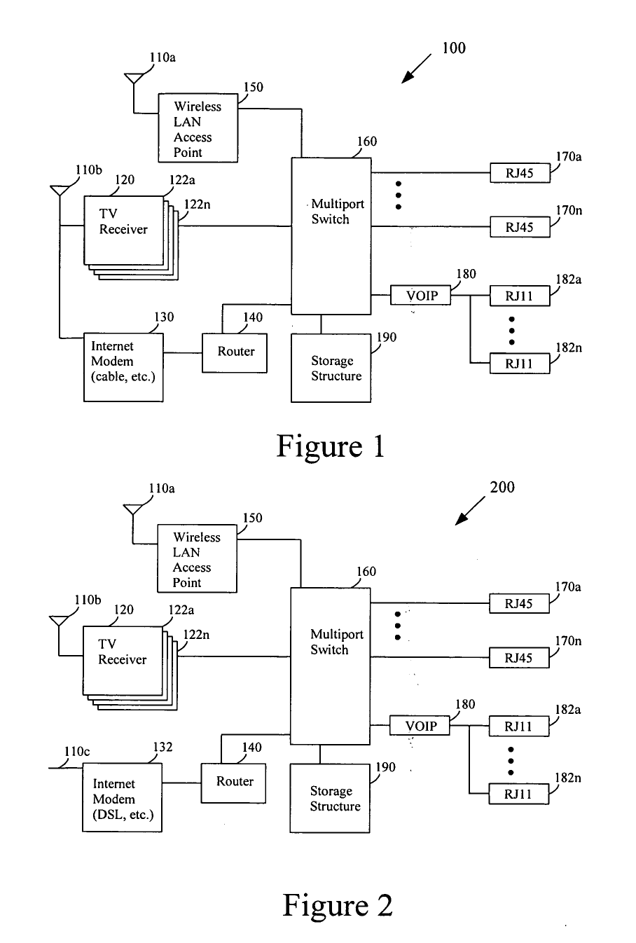

FIG. 1 depicts a consolidated content apparatus and local area network according to an embodiment of the invention. A number of communication ports 110a-110b are depicted to connect with communication service providers and communicate over a medium such as cable television or wireless WiFi (IEEE 802.11), for example. In this embodiment, the invention receives television and internet service from a cable provider and is connected to the cable provider by port 110b, which would be a copper or fiber-optic connection. It's also anticipated that a satellite provider like Dish Networks would connect via port 110b as well. A television receiver 120 is coupled to port 110b to receive and tune television signals from the cable provider. The receiver 120 can include a number of tuners 122a-122n. Internet modem 130 is also coupled to port 110b to communicate via internet protocol with the internet. A router 140 is coupled to the internet modem to direct signals in a local area network (LAN). The router may also perform dynamic host control protocol (DHCP) to assign intranet numbers to devices on the LAN. The router may also perform network address translation (NAT) and even firewall and other functions to prevent devices on the LAN from being probed on otherwise maliciously affected through the internet connection.

In one embodiment, the communication port 110b receives a signal from a cable or satellite provider and the provider equipment provides digitally encoded compressed content to the receiver 120 through a digital interface. One aspect of the invention involves the protection of digital rights, wherein television receiver 120 provides digital rights management protection for the satellite content through digital transmission content protection (DTCP), DTCP over internet protocol (DTCP-IP) or similar mechanisms. In such an aspect, the receiver 120 performs content protection for cable television and satellite television. In this case, the television content is delivered to receiver 120 in a digital form and the receiver 120 performs key exchange, digital rights management, content decryption and possibly even re-encryption. It is anticipated that a plurality of digital rights management protection techniques are possible in this interface, receiver structure and invention.

A wireless LAN access point 150 is provided and coupled to port 110a for communicating with wireless devices. The components 120, 14 and 150 are coupled to a multiport switch 160 that provides the connectivity for the local area network. In one embodiment, the LAN is deployed in a residence, and in another embodiment, the LAN is deployed in a business or multi-residential setting. Many variations on customer deployments are anticipated by the invention.

Coupled to the multiport switch are also a number of connectors 170a-170n that provide wire connections to the switch. These can be located at the deployment location for connecting client devices to the network. These client devices can include, for example, computers, music devices, television set top boxes and so forth. One such client is described in greater detail below. Alternately, the clients can communicate with the wireless LAN via port 110a.

Also coupled to the multiport switch is a voice over internet protocol (VOIP) center 180 that provides telephone service to the deployed location. This is done through a number of connectors 182a-182n that support telephone plug in. In one aspect, the VOIP center plugs into a home telephone network and provides dial tone and other features that turn all the existing telephones into internet phones. The VOIP center may include sophisticated functions, for example, private branch exchange or other functions to support multiple telephone numbers, internal conference calling, and so forth at the deployment location.

A storage structure 190 is also coupled to the multiport switch. The storage structure can serve a number of functions in the LAN. In one aspect, the storage structure is a network attached storage (NAS). In another aspect, the storage structure is a digital recorder that provides program storage and access to client devices connected to the LAN. In yet another aspect, the storage structure is a server computer capable of many functions. Since all the clients on the LAN have access to the storage structure, they can all access the programs stored therein. These aspects are described below in more detail.

FIG. 2 depicts a consolidated content apparatus and local area network according to another embodiment of the invention. This embodiment shows a variation in the embodiment of FIG. 1 by employing a DSL internet modem coupled to port 110c, which would be connected to the telephone company's central office. In this example, the television receiver port 110b could be connected to cable, satellite, or even to a rooftop antenna capable of receiving conventional wireless broadcast signals (analog or digital).

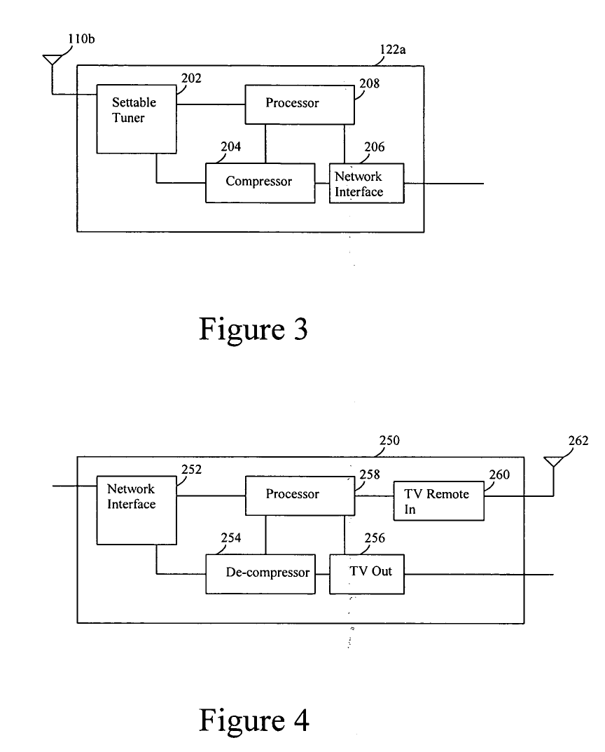

FIG. 3 depicts a television tuner according to an embodiment of the invention. As shown in FIG. 1, the receiver 120 can include a number of tuners 122a-122n. FIG. 3 depicts an exemplary tuner 122a. The tuner is coupled to the television port 110b. A settable tuner 202 is coupled to the port and is configured to acquire a particular television station based on the communication parameters of the station (e.g. frequency) and convert the television signal into data packets. A compressor 204 is coupled to the tuner 202 and configured to compress the television data into a defined format using a defined algorithm (e.g. MPEG, DIVX or other format). A network interface 206 is coupled to the compressor and configured to communicate via Ethernet protocol with the switch 160. The network interface includes a media access control (MAC) to support the communications. A processor 208 is coupled to the settable tuner, compressor and network interface and configured to properly set the tuner and respond to commands from client devices via the switch. Thus, the television signal is converted to data packets that are then sent to client devices on the LAN, for example, to set top boxes that provide television signals out to television sets.

In one aspect, the television receiver assigns tuners to each client on a predetermined basis. For example, if there are 3 client devices on the LAN that each have dedicated access to a television tuner, the first tuner may be associated with the first client, the second tuner may be associated with the second client and so forth. This maps the client devices to the tuners in a one for one basis, but does not permit the number of client devices to scale beyond the number of tuners.

In another aspect, the television receiver assigns tuners to each client as needed. This provisioning of tuners to client devices is advantageous because it permits a few tuners to service a larger number of client devices. In this manner, as one client desires to have television tuner access, the request is granted so long as there is an available tuner. If there is not an available tuner, a response is generated to the client that no tuner is available. The customer could then disconnect another client to free up an available tuner if so desired.

FIG. 4 depicts a client 250 according to an embodiment of the invention. A network interface 252 is provided for a physical interface to the LAN. The network interface includes a media access control (MAC) to support the communications. A de-compressor 254 is coupled to the network interface and configured to decompress the television signal for rendering on a television or other appliance. This is, for example, an MPEG decoder or other similar device. A TV out connector 256 provides television signal in a native mode for the television to render the signal. A processor 258 is coupled to the elements of the client and manages the elements. A TV remote input 260-263 is provided to support a customer sending commands to other LAN client devices, for example, the television receiver or the storage structure. The processor may also contain a memory to execute menu dialog with the customer for using the remote. For example, the processor may generate command lines that the customer can select from.

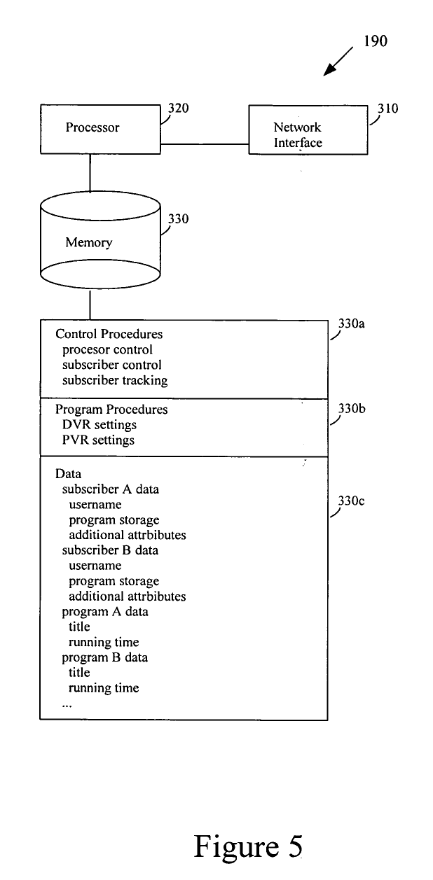

FIG. 5 depicts a storage structure 190 according to an embodiment of the invention. The storage structure includes a network interface 310 that includes a MAC for communication purposes. A processor 320 is coupled to the network interface and configured to manage the storage structure. A memory 330 is coupled to the processor and includes a number of compartments. Compartment 330a includes control procedures for the processor to execute and control. Subscriber control and tracking include features that support the user's access to the subscribed features and track the usage for later retrieval. Compartment 330b includes program procedures for recording content (e.g. television programs) in the memory. In this aspect, the storage structure can acts as a digital video recorder in conjunction with the television receiver to record television programs. Compartment 330c includes subscriber data, and also includes digital content like television programs that can be stored and recalled by client devices. Since all the clients on the LAN have access to the storage structure, they can all access the program content stored therein. In addition, the pool of memory in the storage structure can be shared among the clients, increasing the storage available to a client. For example, with N clients, distributing the memory among the clients equally means each client can fill only 1/N of the memory. Aggregating all the memory into one pool, instead of distributing among the clients makes it possible for any client to fill all the memory and achieve an N times improvement.

Advantages of the invention include consolidation of content communications for customers, resulting in more robust and less expensive access to content delivery and communication. In addition, by adding a plurality of tuners to the content receiver, client devices on the LAN can access and use tuners as requested, thereby reducing the hardware requirements while still providing quality service to client devices.

While the invention has been described in terms of several embodiments and the best mode, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A consolidated content apparatus comprising:
a local area network including a plurality of communication ports adapted to connect to a plurality of communication mediums, wherein at least one of the ports is a television tuner port;
a television receiver coupled to the television port and configured to receive a television signal and to convert the television signal into television program packets; and
a multiport switch having a number of local ports coupled to the communication ports and the television tuner.

2. The consolidated content apparatus of claim 1, further comprising:
at least one client coupled to the local area network and configured to send commands to the television receiver and to receive the television program packets; and
wherein the television receiver is responsive to commands from the client.

3. The consolidated content apparatus of claim 1, further comprising:
a plurality of client devices coupled to the local area network and configured to send commands to the television receiver for receiving and communicating particular television programs to the client;
wherein the television receiver comprises a plurality of tuners each configured to receive a television signal and to convert the television signal into television program packets responsive to commands from the client devices.

4. The consolidated content apparatus of claim 3, wherein:
the television receiver assigns tuners to each client as needed.

5. The consolidated content apparatus of claim 3, wherein:
the television receiver assigns tuners to each client on a predetermined basis.

6. The consolidated content apparatus of claim 2, further comprising:
a storage structure coupled to the multiport switch and responsive to commands from the client to store and retrieve data packets.

7. The consolidated content apparatus of claim 3, further comprising:
a storage structure coupled to the multiport switch and responsive to commands from the client devices to store and retrieve data packets.

8. The consolidated content apparatus of claim 6, wherein:
the storage structure comprises a server computer and is configured to store television programs in response to commands from the client.

9. The consolidated content apparatus of claim 7, wherein:
the storage structure comprises a server computer and is configured to store television programs in response to commands from the client devices.

10. The consolidated content apparatus of claim 9, wherein:
each of the client devices has access to the storage structure thereby increasing the storage for any one client up to N times the storage that would otherwise be allocated to each client on a divisional basis.

11. A television receiver for use in a consolidated content apparatus comprising:
a plurality of tuners each comprising (a) a terminal adapted to receive a television signal, (b) a settable tuner coupled to the terminal and configured to tune a television signal, (c) a compressor coupled to the settable tuner and configured to compress the television signal to create a compressed signal, (d) a media access control coupled to the compressor and adapted to communicate with a local area network, and (e) a processor coupled to the settable tuner, the compressor and the media access control and configured to control the tuner based on instructions received from the local area network.

12. The television receiver of claim 11, wherein:
each of the tuners is addressable by its respective media access control address.

13. The television receiver of claim 11, wherein:
each of the tuners is configured to convert the television signal into television program packets.

14. The television receiver of claim 11, further comprising:
a storage structure comprising a processor and memory configured to store television programs in response to commands from a client.

15. The television receiver of claim 12, wherein:
the tuners as provisioned to a client as needed, and then the provisioned tuner is responsive to commands from the client.

16. The television receiver of claim 12, wherein:
the tuners as provisioned to a client on a predetermined basis.

17. A consolidated content apparatus comprising:
a local area network including a means for connecting to a plurality of communication mediums, wherein at least one of the communication mediums is television;
means for receiving a television signal and converting the television signal into television program packets; and
means for communicating the television program packets to a plurality of client devices coupled to the local area network and for communicating commands from the client devices to the means for receiving a television signal; and
wherein the television receiving means is responsive to commands from the client devices.

18. The consolidated content apparatus of claim 17, further comprising:
means for storing television programs responsive to commands from the client devices.

19. The consolidated content apparatus of claim 9, wherein:
each of the client devices has access to the means for storing television programs thereby increasing the storage for any one client up to N times the storage that would otherwise be allocated to each client on a divisional basis.
